(19) United States
(12) Patent Application Publication
(10) Pub. No.: US 2026/0091387 A1
(43) Pub. Date: Apr. 2, 2026

(54) A Metering Stack and System for Collecting a Target Sample for Testing

(71) Applicant: Google LLC, Mountain View, CA (US)

(72) Inventors: Junyu Mai, Walnut Creek, CA (US); Herschel Max Watkins, Sausalito, CA (US); Paul Joseph Silberschatz, San Francisco, CA (US); Keith Adam Wong, San Francisco, CA (US)

(21) Appl. No.: 19/113,785

(22) PCT Filed: Sep. 21, 2022
(86) PCT No.: PCT/US2022/044222

§ 371 Date: Mar. 20, 2025

(51) Int. Cl. B01L 3/00

(52) U.S. Cl. CPC B01L 3/502723; B01L 2200/0684; B01L 2300/0864; B01L 2400/0481

(57) ABSTRACT

A metering stack for collecting a target sample includes a channel layer spacing a top layer from a bottom layer, where the top, bottom, and channel layers together define a channel. The channel has an inlet end, a main channel portion, a separation portion, and one or more dispensing portions. A vent is defined within the metering stack proximate the separation portion, where the vent allows air to enter the metering stack into the separation portion. The vent has a first wall extending between a first end and a second end, and a curved wall extending between the first end and the second end, with at least a portion of the first wall being closer than the curved wall to the main channel portion and with the first wall being at an angle relative to a main axis of the main channel portion.

### FIELD OF THE INVENTION

The present disclosure relates generally to a point-of-care (POC) testing system that includes a metering stack for collecting a target sample for testing and a reader for testing the target sample collected via the metering stack.

### BACKGROUND

Point-of-care (POC) testing refers to performing medical diagnostic tests at the time and place that the patient is being treated. POC testing is advantageous over traditional diagnostic testing where patient samples are sent out to a laboratory for further analysis, because the results of traditional diagnostic tests may not be available for hours, if not days or weeks, making it difficult for a caregiver to assess the proper course of treatment in the interim.

Of particular interest in POC testing is the determination of the level of hemoglobin, thyroid markers (e.g., T3, free T4, thyroid stimulating hormone, etc.), inflammatory markers (e.g., C-reactive protein, etc.), vitamins, cholesterol, lipoproteins, triglycerides, metabolic syndrome markers, glucose, glycated albumin, serological levels of antibodies against a disease, and/or the like. However, many currently available assay devices for at home use only measure for a single analyte, while it would be useful to measure multiple analytes. Additionally, many assay devices are complicated, making it difficult for a user to correctly operate, leading to inaccurate test results.

Thus, it would be desirable to have a POC system that has a metering stack or assay device that can be easily and correctly used by a user to quickly collect a predefined volume of a target sample and allow for multiple analytes to be measured from the target sample.

### SUMMARY OF THE INVENTION

Aspects and advantages of embodiments of the present disclosure will be set forth in part in the following description, or can be learned from the description, or can be learned through practice of the embodiments.

One example aspect of the present disclosure is directed to an assay device or metering stack (as part of a POC testing system) for collecting a target sample for testing. Particularly, the metering stack has a top layer, a bottom layer, and a channel layer spacing the top layer from the bottom layer. The top layer, the bottom layer, and the channel layer together define a channel. The channel has an inlet end for receiving the target sample, a main channel portion connected to the inlet end, a separation portion connected to the main channel portion, and one or more dispensing portions connected to the separation portion. A vent is defined within the metering stack proximate the separation portion of the channel, the vent having a first wall and a curved wall, where the first wall extends between a first end and a second end, and where the curved wall extends between the first end and the second end. At least a portion of the first wall is closer than the curved wall to the main channel portion and the first wall is at an angle relative to a main axis of the main channel portion. The vent allows air to enter the metering stack into the separation portion.

Another aspect of the present disclosure is directed to a testing system (the POC testing system) for collecting a target sample for testing, the testing system having a metering stack and a reader. The metering stack has a top layer, a bottom layer, and a channel layer spacing the top layer from the bottom layer. The top layer, the bottom layer, and the channel layer together define a channel. The channel has an inlet end for receiving the target sample, a main channel portion connected to the inlet end, a separation portion connected to the main channel portion, and one or more dispensing portions connected to the separation portion. A vent is defined within the metering stack proximate the separation portion of the channel, the vent having a first wall and a curved wall, where the first wall extends between a first end and a second end, and where the curved wall extends between the first end and the second end. The first wall is at an angle relative to a main axis of the main channel portion. The vent allows air to enter the metering stack into the separation portion. The reader is configured to at least partially receive the one or more dispensing portions of the metering stack.

Yet another aspect of the present disclosure is directed to a metering stack for collecting a target sample for testing, the metering stack comprising:
a top layer, a bottom layer, and a channel layer spacing the top layer from the bottom layer in
a vertical direction. The top layer, the bottom layer, and the channel layer together define a channel having an inlet end for receiving the target sample, one or more dispensing portions configured to receive the target sample from the inlet end, and a connecting portion connected between the inlet end and each of the one or more dispensing portions in a longitudinal direction to guide the target sample from the inlet end to each of the one or more dispensing portions. Particularly, the channel layer is at least partially spaced apart from one or both of the top layer and the bottom layer in the longitudinal direction at the inlet end.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a front view of an exemplary collection unit in accordance with aspects of the present subject matter, particularly illustrating a cartridge and a metering stack;

FIG. 2 illustrates a detailed view of an inlet of an exemplary metering stack in accordance with aspects of the present subject matter;

FIGS. 3A and 3B illustrate different views of first example aspects of the inlet shown in FIG. 2 in accordance with aspects of the present subject matter, particularly FIG. 3B is a cross-sectional view taken at 3B-3B of FIG. 3A;

FIGS. 4A and 4B illustrate different views of second example aspects of the inlet shown in FIG. 2 in accordance with aspects of the present subject matter, particularly FIG. 4B is a cross-sectional view taken at 4B-4B of FIG. 4A;

FIGS. 5A and 5B illustrate different views of other example aspects of the inlet shown in FIG. 2 in accordance with aspects of the present subject matter;

FIG. 6 illustrates a front view of the metering stack of the collection unit shown in FIG. 1 in accordance with aspects of the present subject matter, particularly illustrating a first example separation chamber;

FIG. 7 illustrates another front view of the metering stack of the collection unit shown in FIG. 1 in accordance with aspects of the present subject matter, particularly illustrating a second example separation chamber;

FIGS. 8A and 8B illustrate different views of the exemplary metering stack shown in FIG. 7 in accordance with aspects of the present subject matter, particularly illustrating vents in a top layer and a bottom layer of the metering stack, with FIG. 9B illustrating a cross-sectional view taken at 8B-8B in FIG. 8A;

FIGS. 9A and 9B illustrate different views of an exemplary metering stack and a reader for use with the metering stack in accordance with aspects of the present subject matter, particularly illustrating a window in a top layer of the metering stack, with FIG. 9B illustrating a cross-sectional view taken at 9B-9B in FIG. 9A;

FIGS. 10A and 10B illustrate different views of an exemplary metering stack and a reader for use with the metering stack in accordance with aspects of the present subject matter, particularly illustrating the reader having bumps corresponding to dispensing sites of the metering stack;

FIGS. 11A and 11B illustrate different views of an exemplary metering stack in accordance with aspects of the present subject matter, particularly illustrating the metering stack not having a separate mesh layer and dispensing site layer, with FIG. 11A illustrating a cross-sectional view taken at 11A-11A in FIG. 11B;

FIG. 12 illustrates a cross-sectional view of an exemplary metering stack in accordance with aspects of the present subject matter, particularly illustrating the metering stack having a merged mesh layer and dispensing site layer; and

FIG. 13 illustrates a method of fabricating a collection unit in accordance with aspects of the present subject matter.

Reference numerals that are repeated across plural figures are intended to identify the same features in various implementations.

### DETAILED DESCRIPTION

Any of the features, components, or details of any of the arrangements or embodiments disclosed in this application, including without limitation any of the cartridge embodiments and any of the testing or assay embodiments disclosed below, are interchangeably combinable with any other features, components, or details of any of the arrangements or embodiments disclosed herein to form new arrangements and embodiments.

Generally, the present disclosure is related to an assay device or metering stack for determining a concentration of one or more analytes in a target sample. The metering stack may be part of a testing system (e.g., a POC testing system), for which exemplary embodiments are further discussed below. The metering stack generally has a top layer, a bottom layer, and a channel layer spacing the top layer from the bottom layer. The top layer, the bottom layer, and the channel layer together define a channel, particularly with the top layer bounding a top wall of the channel, the channel layer bounding a sidewall or perimeter of the channel, and the bottom layer bounding a bottom wall of the channel. The channel includes an inlet end for receiving a target sample, a main channel portion connected to the inlet end, a separation portion connected to the main channel portion, and one or more dispensing portions connected to the separation portion.

In some aspects, the metering stack has one or more features for helping a user locate the inlet end. For instance, the metering stack may have a protruding portion that extends outwardly from a housing, where the inlet end for receiving a target sample may extend across a large portion of a width of the protruding portion. In one instance, the metering stack could have markings proximate the inlet end to indicate a center of the inlet end and/or the main channel portion. In some instances, the inlet end may have a curved contour that may generally fit to a finger to assist a user in locating the inlet site. In some instances, the channel layer may be at least partially spaced apart from one or both of the top layer and the bottom layer at the inlet end to help prevent the user from blocking an opening of the main channel portion during collection. In one instance, one of the top layer or the bottom layer may extend beyond the other of the top or bottom layer at the inlet end and/or the inlet end may have a flared or “spoon-shaped” portion, each of which may further help indicate the inlet site as well as allow for a larger volume of the target sample to be collected.

A vent is defined in the metering stack at the separation chamber that allows air to vertically enter the separation chamber, where the target sample is then forced to flow around the air in the separation chamber, along a perimeter of the separation chamber. The vent is defined by an opening in the top layer and an opening in the bottom layer, where the openings are at least partially aligned in the vertical direction. In some instances, the openings of the vent have the same shape. In one instance, the vent may have an arched shape, with a flat wall and a curved wall, where the flat wall is generally at an angle (e.g., perpendicular) to a central axis of the main opening channel. When the target sample entering the separation chamber impinges on the air proximate the flat wall of the vent, the target sample is split into two first flow paths, moving in different directions along the perimeter of the separation chamber, near the flat wall of the vent. In some instances, a transition between the main opening channel and the separation chamber has small radiused corners which also help to direct the flow of the target sample into the two first flow paths. The arched vent may have tight corners transitioning between the flat wall and the curved wall. Thus, each of the first flow paths is sharply transitioned around the tight corners, the tight corners further encouraging the target sample to flow around the curved wall into second flow paths. In some instances, the separation portion may also include transition portions proximate the curved wall of the vent, where the outer perimeter of the separation portions at each of the transition portions is generally parallel to the central axis of the main opening channel. The transition portions increase the length of the flow path of the target sample before reaching the different dispensing portions. The perimeter of the separation chamber between the first flow paths and the transition portions may have tight (e.g., perpendicular) angles, which may help slow the target sample before flowing along the transition portions. Generally, longer flow paths and slower speeds of the target sample encourage more controlled distribution of the target sample between the dispensing portions.

With regards to helping a user insert the metering stack into a reader correctly, the metering stack may be asymmetrical in at least one direction, so that the user is less likely to insert the unit into the reader incorrectly. In one instance, a thickness of the top layer of the metering stack over the dispensing sites is reduced to reduce the pressure required to dispense the target sample from the dispensing sites for analysis by the reader. In some instances, bumps will be added above the dispensing sites and/or onto the bottom of the press bar on the reader, so that less pressure is required to dispense the target sample from the dispensing sites for analysis by the reader.

Additionally, the speed at which the filling of the target sample from the inlets of the dispensing sites into the dispensing sites into the reader can be controlled. For instance, in some embodiments, the bottom layer of the metering stack includes a spot layer (made of impermeable material) and a mesh layer (made of permeable material), where the spot layer creates a step within the dispensing sites that partially covers the mesh layer, and where the target analyte sample is generally dispensable through the mesh layer adjacent the step during dispensing. The target sample changes directions as it drops down at the step to fill the dispensing site, which slows the dispensing site filling. In some embodiments, the spot layer and the mesh layer may be at least partially merged in a vertical direction to reduce the thickness of the step within the dispensing site to increase dispensing site filling speed while also reducing pressure required to dispense the target sample from the dispensing sites. In other embodiments, the mesh layer is omitted, and the spot layer instead includes small openings or pores at the dispensing sites that would prevent the target sample from dripping out without the pressure from the press bar, which would completely remove the step and increase dispensing site filling speed while also reducing pressure required to dispense the target sample from the dispensing sites.

In general, the target analyte referenced herein is contained within a biological fluid, non-limiting examples of which include blood, plasma, serum, saliva, sweat, urine, lymph, tears, synovial fluid, breast milk, and bile, or a component thereof, to name just a few. In certain preferred embodiments, the biological fluid is blood. For example, in one embodiment, the assay systems of the present disclosure are useful for providing patients with POC information regarding target analytes in their blood composition. In particular, the assay systems of the present disclosure can be used to determine the concentration of hemoglobin and optionally other analytes in a blood fluid sample. Other analytes that can be measured in blood via other receiving chambers that may be present as part of the assay system include thyroid markers (e.g., T3, free T4, thyroid stimulating hormone, etc.), inflammatory markers (e.g., C-reactive protein, etc.), vitamins, cholesterol, lipoproteins, triglycerides, metabolic syndrome markers, glucose, glycated albumin, and serological levels of antibodies against a disease. However, it should be appreciated that any other suitable fluid may be tested for a target analyte. For instance, water or other liquids that may be ingested may be tested for lead, fluoride, iron, sodium, etc. to determine if the liquid is safe.

With reference now to the figures, example embodiments of the present disclosure will be discussed in further detail. First, the cartridge or metering stack will be discussed, followed by the reader as contemplated by the present disclosure.

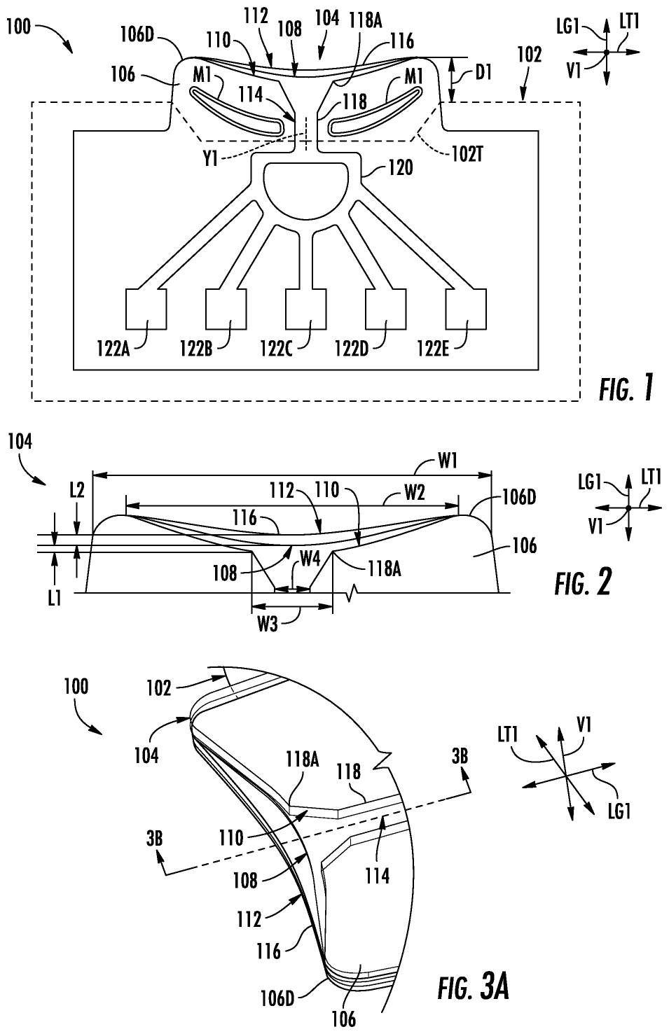

Referring now to FIG. 1, a top view of an exemplary collection unit 100 is illustrated in accordance with aspects of the present subject matter. Particularly, FIG. 1 illustrates a housing or cartridge 102 and a metering stack 104 that is used in conjunction with an assay stack (not shown) to carry out one or more assays to determine a level of one or more analytes present in a biological fluid sample. The cartridge 102 is generally configured to receive the metering stack 104 such that the metering stack 104 is at least partially positioned within the cartridge 102. For instance, in some embodiments, the cartridge 102 defines an opening 102T at a first end of the cartridge 102 along a longitudinal direction LG1. The metering stack 104 has a protruding portion 106 configured to extend through the opening 102T and beyond the first end of the cartridge 102 by a first distance D1 in the longitudinal direction LG1 when received within the cartridge 102, such that the collection unit 100 is not symmetric about a lateral axis extending parallel to the longitudinal direction LT1. As such, a user is more likely to understand without explicit instruction that the protruding portion 106 is intended to receive a target sample. It should be appreciated that, in some embodiments, the cartridge 102 is optional such that the metering stack 104 may be used without the cartridge 102. It should additionally be appreciated that, while the cartridge 102 is outlined as being generally rectangular, the cartridge 102 may have any suitable shape.

The metering stack 104 includes a top layer 108, a channel layer 110, and a bottom layer 112, where the channel layer 110 spaces the top layer 108 from the bottom layer 112 in a vertical direction V1. Together, the layers 108, 110, 112 define a channel 114. Particularly, the top layer 108 bounds a top surface of the channel 114, the channel layer 110 defines a sidewall of the channel 114, and the bottom layer 112 bounds a bottom surface of the channel 114. As will be described in greater detail below, the channel 114 has an inlet opening or end 116 configured to receive the target sample and a connecting portion (e.g., a main channel portion 118 connected to the inlet end 116, and a separation portion 120 connected to the main channel portion 118) connected between the inlet end 116 and each of the at least one dispensing site or portion 122 (e.g., first dispensing portion 122A, a second dispensing portion 122B, a third dispensing portion 122C, a fourth dispensing portion 122D, and a fifth dispensing portion 122E) within the bottom layer 112 that is connected to the separation portion 120. Each of the dispensing portions 122 may be configured to receive a portion of the target sample for testing. It should be appreciated that while the channel 114 is shown as having five dispensing portions 122, the channel 114 may include any suitable number of dispensing portions 122, such as two, three, four, six, seven, eight, or more dispensing portions 122. Additionally, it should be appreciated that, in some embodiments, the metering stack 104 may include indentations or markings M1 on the protruding portion 106 at either side of the channel 114 to indicate where the channel 114 is to a user.

In general, the dimensions of the channel 114 are selected such that capillary action is generated to help draw the biological sample into the channel and towards the dispensing portions. In some instances, it is preferable that at least one of the surfaces of the top layer 108, the channel layer 110, and the bottom layer 112 within the channel 114 is hydrophilic to further encourage capillary action to draw the biological sample into the channel 114 and towards the dispensing portions 122. For instance, in one embodiment, at least a portion of the bottom layer 112 within the channel 114 is hydrophilic. Additionally, in some instances, the outer surfaces of the metering stack 104, at least proximate the inlet end 116, may be hydrophobic to prevent staining of the target sample at the inlet end 116 of the metering stack 104 and to prevent the target sample from flowing along the exterior surfaces of the metering stack 104 into the cartridge 102.

The inlet end 116 of the channel 114 is positioned at a distal end 106D of the protruding portion 106 along the longitudinal direction LG1 such that it is easy for a user to locate. In some instances, as shown in detail in FIG. 2, the distal end 106D of the protruding portion 106 extends along a width W1 in the lateral direction LT1, and the inlet end 116 of the channel 114 extends across a width W2 in the lateral direction LT1. The width W2 of the inlet end 116 extends across a substantial portion of the width W1 of the distal end 106D of the protruding portion 106. For instance, the width W2 of the inlet end 116 may extend across a majority of the width W1 of the distal end 106D of the protruding portion 106, such as about 60% of the width W1, such as about 70% of the width W1, such as about 80% of the width W1, such as about 90% of the width W1, or such as about all of the width W1. The width W2 may extend in the lateral direction LT1 from 3 mm to 15 mm, such as about 5 mm to 13 mm, such as about 8 mm to 13 mm, such as about 11 mm to 12 mm. Additionally, in one embodiment, the width W2 of the inlet end 116 is greater than a width W3 in the lateral direction LT1 of an opening end 118A of the main channel portion 118, closest to the inlet end 116. In some embodiments, the width of the main channel portion 118 in the lateral direction LT1 tapers from the width W3 at the opening end 118A to a width W4, with the width W4 being smaller than the width W3.

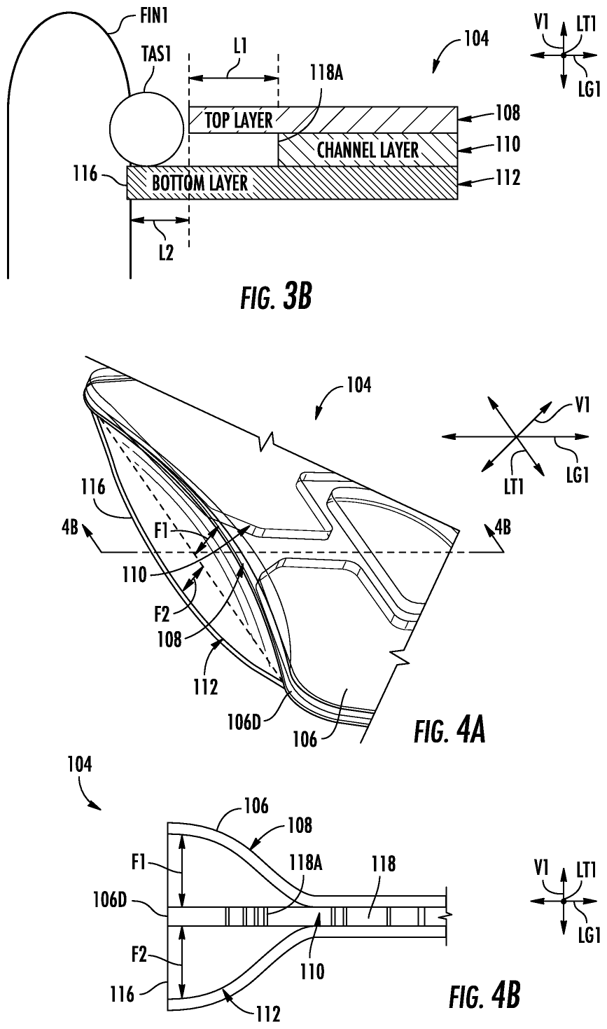

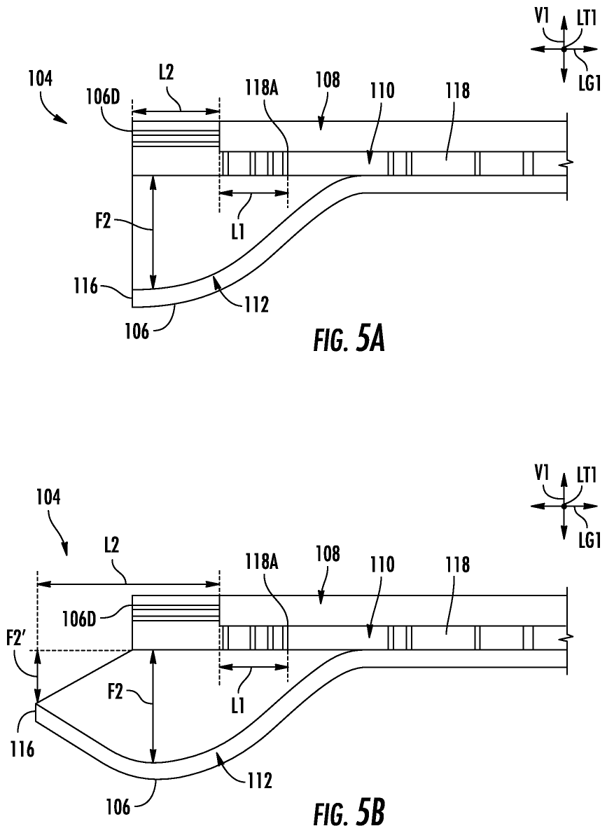

In some embodiments, as particularly shown in at least FIGS. 2 and 3A, the inlet end 116 may be curved to better fit to a sampling location (e.g., a finger). For instance, a distance between the distal end 106D of the protruding portion 106 and the inlet end 116 in the longitudinal direction LG1 may decrease from a center of the inlet end 116 in the lateral direction LT1 towards the outer edges of the inlet end 116 in the lateral direction LT1. In some instances, each of the layers 108, 110, 112 is curved. In other instances, only some of the layers 108, 110, 112 are curved.

In some instances, the channel layer 110 may be at least partially spaced apart from one or both of the top layer 108 or the bottom layer 112 in the longitudinal direction LG1 proximate the inlet end 116. For example, as shown in at least FIGS. 2 and 3B, the channel layer 110 is spaced apart from both the top layer 108 and the bottom layer 112, at least at the center of the inlet end 116 in the lateral direction LT1. Particularly, the channel layer 110 is spaced apart from the top layer 108 in the longitudinal direction LG1 by a first distance L1 at the center of the inlet end 116 in the lateral direction LT1, and the bottom layer 112 is spaced apart from the top layer 108 in the longitudinal direction LG1 by a second distance L2 at the center of the inlet end 116 in the lateral direction LT1. The first distance L1 may be from 0.2 mm to 1 mm, such as from 0.5 mm to 0.75 mm, and/or the like. The second distance L2 may be from 0.2 mm to 5 mm, such as from 0.5 mm to 3 mm, such as from 0.5 to 1 mm, and/or the like. As indicated above, in one embodiment, the layer(s) 108, 110, 112 are curved such that the first distance L1 between the channel layer 110 and the top layer 108 and/or the second distance L2 between the top layer 108 and the bottom layer 112 decreases from the center of the inlet end 116 towards the outer edges of the inlet end 116 in the lateral direction LT1, such that the channel layer 110 and the layer(s) 108, 112 are even with each other along the longitudinal direction LG1 at the outer edges of the inlet end 116 in the lateral direction LT1. Generally, by at least partially spacing the channel layer 110 from the layer(s) 108, 112, the opening end 118A of the main channel portion 118 is less likely to be blocked by the user if the user presses harder than necessary against the inlet end 116 when collecting the target sample analyte.

In some instances, the first and second distance L1 and L2 are selected such that the top and bottom layers 108, 112 are not even with each other along the longitudinal direction LG1. As such, the inlet end 116 may have a shelf onto which a user may press a target location (e.g., finger FIN1 in FIG. 3B) against to scoop the target analyte (e.g., TAS1 in FIG. 3B), and further prevent the opening end 118A of the main channel portion 118 from being blocked. However, in other embodiments, the top and bottom layers 108, 112 may be even with each other along the longitudinal direction LG1. It should be appreciated, that while not shown, the channel layer 110 may be spaced apart from only one of the top and bottom layers 108, 110 in the longitudinal direction LG1. Additionally, in some embodiments, as in FIG. 3B, a distance between the channel layer 110 and one or both of the top layer 108 and the bottom layer 112 in the vertical direction V1 is essentially constant.

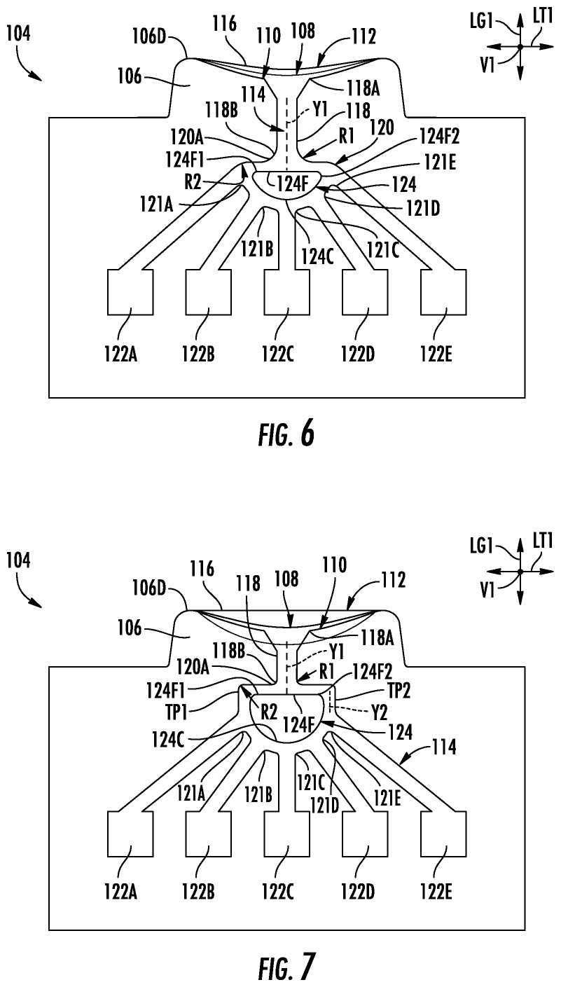

Referring now to FIGS. 4A-5B, in some instances, the inlet end 116 of the metering stack 104 may be flared in the vertical direction V1. In such instances, the inlet end 116 may be taller in the vertical direction V1 than the main channel portion 118, which better indicates to a user where the sample should be received and allows for more target sample to be collected. For instance, as shown in FIGS. 4A and 4B, in some instances, the top layer 108 and the bottom layer 112 are both flared. In such instances, as best shown in FIG. 4B, a distance F1 in the vertical direction V1 between the top layer 108 and the channel layer 110 and a distance F2 in the vertical direction V1 between the bottom layer 112 and the channel layer 110 decreases from the inlet end 116 towards the opening end 118A of the main channel portion 118. For instance, the distances F1, F2 at the inlet end 116 may be from 0.5 mm to 2 mm, such as from 0.75 mm to 1.5 mm, and/or the like. Additionally, as particularly shown in FIG. 4A, the distances F1, F2 may decrease from a center of the metering stack 104 in the lateral direction L1 to the outer edges in the lateral direction LT1 such that the layers 108, 110, 112 meet in the vertical direction V1 at the outer edges in the lateral direction LT1.

In other instances, only one of the top layer 108 or the bottom layer 112 is flared. For instance, as shown in FIGS. 5A and 5B, only the bottom layer 112 is flared. Further, in some instances, the flared layer 108, 112 is spoon-shaped in cross section. For instance, as shown in FIG. 5B, the end of the bottom layer 112 at the inlet end 116 may extend beyond the ends of both the top layer 108 and the channel layer 110 at the inlet end 116 in the longitudinal direction LG1 at the center of the metering stack 104 in the lateral direction LT1. The distance in the vertical direction V1 between the bottom layer 112 and the channel layer 110 initially increases from a first distance F2′ at the extended end of the bottom layer 112 to the distance F2 at the distal end 106D of the protruding portion 106, where the layers 108, 110, 112 are even at the outer edges in the lateral direction LT1. The distance between the bottom layer 112 and the channel layer 110 may continue to decrease from the distal end 106D of the protruding portion 106 towards the main channel portion 118. The first distance F2′ may be selected such that the inlet end 116 is still taller in the vertical direction V1 than the main channel portion 118. In such instances, a user may be more likely to press against the spoon shape of the bottom layer 112 instead of trying to press against the opening end 118A of the main channel portion 118.

Referring now to FIGS. 6-8B, example aspects of the channel 114 defined by the metering stack 104 will be described in greater detail. Particularly, as indicated above, the inlet end 116 of the channel 114 is connected to the main channel portion 118. More particularly, the main channel portion 118 extends between the opening end 118A and a distributing end 118B along a main axis Y1, parallel to the longitudinal direction LG1. The inlet end 116 of the channel 114 is connected to the opening end 118A of the main channel portion 118 such that the target sample received at the inlet end 116 may be directed into the main channel portion 118. The distributing end 118B of the main channel portion 118, in turn, is connected to an inlet end 120A of the separation portion 120 of the channel 114, such that the target sample is then directed into the separation portion 120.

A vent 124 is defined in the metering stack 104 at the separation portion 120 that connects the separation portion 120 to atmosphere. The vent 124 may help divide the target sample received from the main channel portion 118 for delivery to the different dispensing portions 122. For instance, the vent 124 is an opening in the top layer 108 and/or the bottom layer 112, as will be described in greater detail below, that allows air to enter directly into the separation portion 120 along the vertical direction V1 such that the target sample entering the separation portion 120 is forced to flow around the air and along a perimeter of the separation portion 120. In one instance, the vent 124 is shaped like an arch with a flat wall 124F and curved wall 124C. The flat wall 124F extends substantially linearly between a first end 124F1 and a second end 124F2, and the curved wall 124C extends in a curved manner between the first and second ends 124F1, 124F2. For example, the curved wall 124C may follow an essentially continuous, single curve between the first and second ends 124F1, 124F2. At least a portion of the flat wall 124F is closer than the curved wall 124C to the main channel portion 118. The flat wall 124F is generally at an angle to the main axis Y1 of the main channel portion 118. For instance, the flat wall 124F may be substantially perpendicular to the main axis Y1 (e.g., such as less than a 15 degree, less than a 10 degree, less than a 5 degree, less than a 1 degree, etc. difference from 90 degrees). In some instances, the flat wall 124F is centered about the main axis Y1 of the main channel portion 118. The vent 124 may be symmetric about the longitudinal axis LG1 (e.g., about the main channel portion 118).

Due to the orientation of the flat wall 124F to the main channel portion 118, the target analyte flow entering the separation portion 120 in the longitudinal direction LG1 may impinge against the air in the separation portion 120 proximate the flat wall 124F of the vent 124 and be divided evenly into two first flow paths, moving substantially opposite each other in the lateral direction LT1 along the flat wall 124F towards the ends 124F1, 124F2, and substantially perpendicular (e.g., such as less than a 15 degree, less than a 10 degree, less than a 5 degree, less than a 1 degree, etc. difference from 90 degrees) to the main axis Y1. The transitions between the distributing end 118B of the main channel portion 118 and the inlet end 120A of the separation portion 120 of the channel may be curved, each side having a radius R1. The radii R1 may be selected target sample to help divide the target sample within the separation portion 120 into the two first flow paths. For instance, the smaller the radii R1 are (the closer to perpendicular the transitions between the distributing end 118B of the main channel portion 118 and the inlet end 120A of the separation portion 120), the slower the target sample will flow in the first flow paths.

The separation portion 120 is connected to an inlet end 121 of each of the dispensing portions 122 (e.g., first inlet end 121A of the first dispensing portion 122A, second inlet end 121B of the second dispensing portion 122B, third inlet end 121C of the third dispensing portion 122C, fourth inlet end 121D of the fourth dispensing portion 122D, and fifth inlet end 121E of the fifth dispensing portion 122E) proximate the curved wall 124C such that the separation portion 120 directs the target sample to each of the dispensing portions 122. More particularly, each of the two first flow paths of the target sample is directed around a respective, second curve of the separation portion 120 having a radius R2 adjacent a respective end 124F1, 124F2 of the flat wall 124F, and then begins to be delivered to the different inlet ends 121. The second radii R2 may be chosen to affect the flows of target sample about the transition between the flat and curved walls 124F, 124C of the vent 124. For instance, the smaller the second radii R2 are, the slower the target analyte will flow, which helps to control the division of the target analyte between the distribution portions 122.

Each of the inlets 121 may be at least partially aligned with the curved wall 124C of the vent 124 (e.g., at the same position along the longitudinal direction LG1 and/or adjacent in the lateral direction LT1). In one embodiment, as shown in FIG. 6, the first and fifth inlet ends 121A, 121E are also at least partially aligned with the flat wall 124F of the vent 124 (e.g., at the same position along the longitudinal direction LG1 and adjacent in the lateral direction LT1). However, in another embodiment, as shown in FIG. 7, each of the inlets 121 (including the first and fifth inlet ends 121A, 121E) is spaced apart from the flat wall 124F of the vent 124 in the longitudinal direction LG1, such that the inlets 121 are not directly aligned with the flat wall 124F in the lateral direction LT1. In such embodiment, the channel 114 may also include transition portions TP1, TP2 between the flat wall 124F and the first and fifth inlet ends 121A, 121E, each transition portion TP1, TP2 having an axis Y2 that is at an angle relative to the flat wall 124F. For instance, the outermost walls of the transition portions TP1, TP2 in the lateral direction LT1 defined by the channel layer 110 may be substantially parallel to the longitudinal direction LG1, such that the axes Y2 of the transition portions TP1, TP2 may also be substantially parallel to the longitudinal direction LG1. The transition portions TP1, TP2 may extend from 1 mm to 5 mm, such as from 2 mm to 4 mm, and/or the like. The transition portions TP1, TP2 may allow the target analyte traveling in the first flow paths, to fully transition in direction and speed within the second flow paths defined by the transition portions TP1, TP2, before being divided into third flow paths between the transition portions TP1, TP2 and the respective inlet ends 121, which further improves the separation of the target analyte to the different dispensing portions 122. An angle between a respective pair of the first and second flow paths may be substantially perpendicular (e.g., such as less than a 15 degree, less than a 10 degree, less than a 5 degree, less than a 1 degree, etc. difference from 90 degrees). Similarly, an angle between each of the first flow paths and the axis Y1 of the main channel portion 118 may be substantially perpendicular (e.g., such as less than a 15 degree, less than a 10 degree, less than a 5 degree, less than a 1 degree, etc. difference from 90 degrees).

It should be appreciated that the length of the stem channels extending between the inlets 121 and the dispensing sites 122 may be any suitable distance. It should additionally be appreciated that the shape and size of the inlets 121, stem channels, and/or dispensing sites 122 may be selected such that the dispensing sites 122 receive an identical amount of the biological sample or different amounts of the biological sample. Moreover, the stem channels may be of varying shape, size, and/or length.

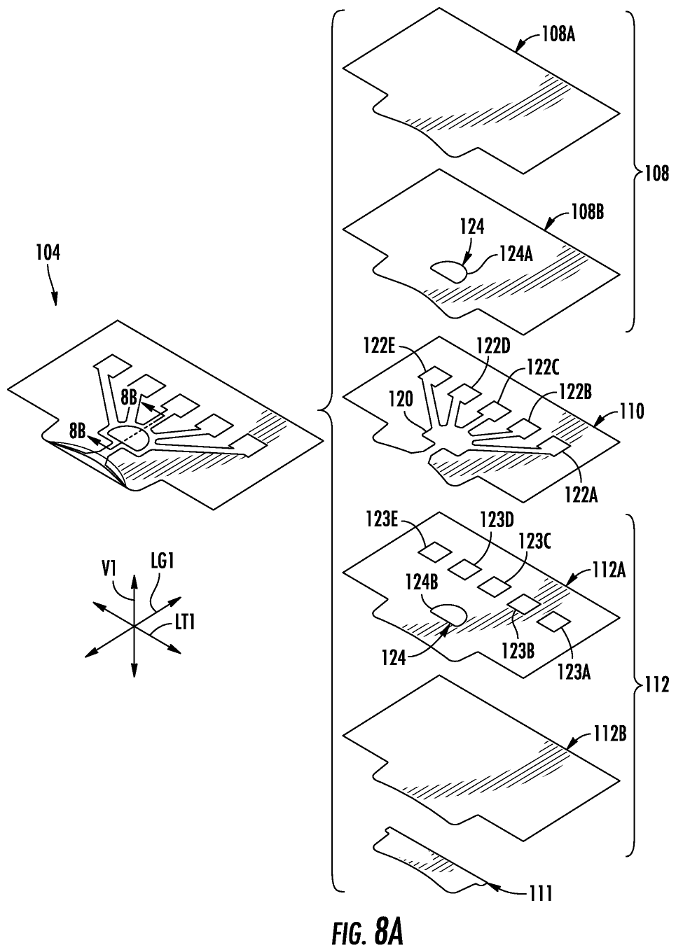

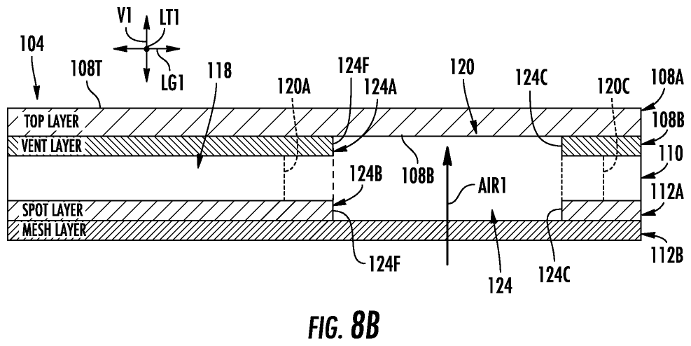

As shown in the exploded view of the metering stack 104 of FIG. 8A and the section view of FIG. 8B, in one instance, the top layer 108 includes a first top layer 108A and a second top layer 108B, where the first and second top layers 108A, 108B are stacked such that the second top layer 108B is positioned between the first top layer 108A and the channel layer 110 in the vertical direction V1. Similarly, in one instance, the bottom layer 112 may include a first bottom layer 112A and a second bottom layer 112B, where the first bottom layer 112A is between the channel layer 110 and the second bottom layer 112B in the vertical direction V1. Additionally, in one instance, the bottom layer 112 may further include a patch layer 111. The lower surface of the patch layer 111 may cover only a portion of the lower surface of the metering stack 104. For instance, the patch layer 111 may cover the protruding portion 106. An upper surface of the first top layer 108A and a lower surface of the patch layer 111 in the vertical direction V1 may be hydrophobic to help prevent staining of the target sample, particularly at the inlet end 116. In some instances, the first and second top layers 108A, 108B may be made from impermeable materials. Meanwhile, the first bottom layer 112A may be made from an impermeable material while the second bottom layer 112B may be made from permeable material. For instance, the permeable material may be a mesh or porous material having a mesh or pore size from 10μm to 300 μm.

As indicated above, the vent 124 may be defined in one or both of the layer(s) 108, 112. For example, in some instances, the vent 124 is defined by a first vent opening 124A in the second top layer 108B and a second vent opening 124B in the first bottom layer 112A. The vent openings 124A, 124B are cutouts extending through the entire thickness of the respective layer 108B, 112A in the vertical direction V1 such that air may move through the layers 108B, 112A in the vertical direction V1. An entirety of the first vent opening 124A is positioned directly vertically above the separation portion 120. Similarly, an entirety of the second vent opening 124B is positioned directly vertically below the separation portion 120. The perimeter (e.g., walls 124F, 124C) of the vent openings 124A, 124B is spaced apart from the perimeter of the separation portion 120, such that the flow paths through the separation portion 120 are defined between the perimeter of the separation portion 120 and the perimeter of the vent openings 124A, 124B. For instance, as particularly shown in FIG. 8B, the inlet end 120A of the separation portion 120 is spaced apart from the flat walls 124F of the vent openings 124A, 124B in the longitudinal direction LG1 and the third inlet end 121C is spaced apart from the curved walls 124C of the vent openings 124A, 124B in the longitudinal direction LG1. In some embodiments, the perimeter (e.g., walls 124F, 124C) of the vent openings 124A, 124B is spaced apart from the perimeter of the separation portion 120 by a constant distance. However, in other embodiments, the perimeter of the vent openings 124A, 124B may be spaced apart from the perimeter of the separation portion 120 in any other suitable manner.

Air (as indicated with arrow AIR1 in FIG. 8B) may flow upwards through the porous, second bottom layer 112B, through the second vent opening 124B in the first bottom layer 112A directly into the separation chamber 120 and then upward into the first vent opening 124A of the second top layer 108B, where it is prevented from flowing out of the metering stack 104 by the first top layer 108A. Air is generally hydrophobic. As such, the target sample entering the separation portion 120 will be urged to flow away from the air AIR1 and instead flow in the first flow paths along the perimeter of the separation portion 120. In some embodiments, the lower surface of the first top wall 108A may be hydrophobic to further prevent the target sample from flowing into the first vent opening 124A. Similarly, in one embodiment, the lower surface of the second top wall 108B may be hydrophilic to help create a capillary force that encourages the target sample to flow in the flow paths around the vent 124.

In one embodiment, the vent openings 124A, 124B of the vent 124 are identical, having the same shape. For example, as shown in FIG. 8A, the vent openings 124A, 124B have the same arched shape. In some embodiments, the vent openings 124, 124B also overlap. For instance, as particularly shown in FIG. 8B, the vent openings 124A, 124B are vertically aligned such that the flat wall 124F of the first vent opening 124A is vertically aligned with the flat wall 124F of the second vent opening 124B, and similarly, that the curved wall 124C of the first vent opening 124A is vertically aligned with the curved wall 124C of the second vent opening 124B. However, it should be appreciated that, in other embodiments, the vent openings 124A, 124B may have different shapes and/or may be alternatively aligned. For instance, in some embodiments, the vent 124 may instead have a circular shape, an oval shape, a square shape, a trapezoidal shape, and/or the like. Similarly, in some embodiments, the vent openings 124A, 124B may not be directly vertically aligned. Moreover, while the separation portion 120 has been shown as having a substantially similarly shaped perimeter to that of the vent 124, the separation portion 120 may have any other suitable shape. It should further be appreciated that, in some embodiments, the first top layer 108A may be completely omitted. For example, the capillary force and/or flow resistance of the channel 114 may be sufficient to prevent the target sample from leaving the metering stack 104 through the first vent opening 124A such that the first top layer 108A is not needed.

The shape of the vent 124 may affect the amount of remaining target sample after dispensing to an assay stack. For example, in some instances, such as when the transition portions TP1, TP2 are present (e.g., as in FIG. 7), as the target sample is dispensed from the dispensing sites 122, more air is allowed to enter into the separation portion 120 via the vent 124. The additional air may prevent the target sample along the first flow paths from leaving the separation portion 120, and thus, the main channel portion 118, from being dispensed, while encouraging the remaining target sample in the separation portion 120 to move toward the stem channels for dispensing from the dispensing sites 122. However, in other embodiments, such as when the transition portions TP1, TP2 are not present (e.g., as in FIG. 6), as the target sample is dispensed from the dispensing sites 122, the additional air also encourages the target sample in the first flow paths of the separation portion 120 to move toward the stem channels for dispensing from the dispensing sites 122, while preventing the target sample in the main channel portion 118 from being dispensed. As such, the amount of target sample dispensed may further be controlled by the shape of the vent 124.

As additionally shown in FIG. 8A, the first bottom layer 112A may also partially define outlets 123 of the dispensing sites 122 (i.e., first outlet 123A of the first dispensing site 122A, second outlet 123B of the second dispensing site 122B, third outlet 123C of the third dispensing site 122C, fourth outlet 123D of the fourth dispensing site 122D, and fifth outlet 123E of the fifth dispensing site 122E) through which the target sample may be expressed from the dispensing sites 122 and then through the permeable second bottom layer 112B of the metering stack 104.

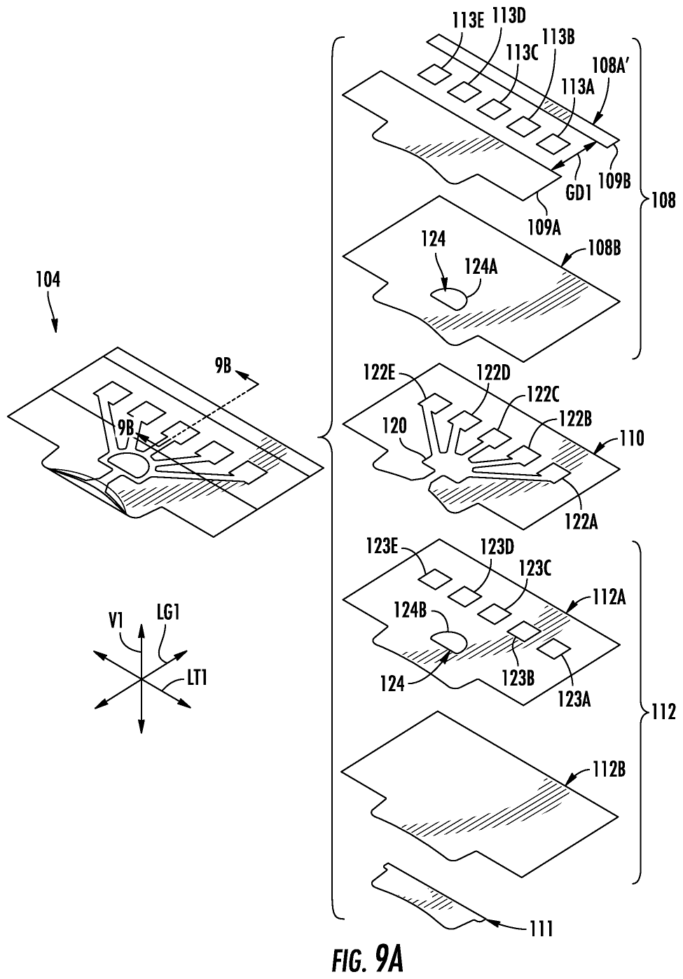

In general, when the metering stack 104 is inserted into an analyzing device or reader (e.g., reader 200 in FIG. 9B), the reader 200 has a press bar 202 configured to selectively press against the top layer 108 of the metering stack 104, at least partially directly vertically above the dispensing sites 122 in the vertical direction V1, such that the target sample may be expressed from the dispensing sites 122 of the metering stack 104 via the outlets 123. Due to the thickness of the top layer 108 (e.g., the combined thickness of the first and second top layers 108A, 108B) in the vertical direction V1, however, it may be difficult for a user to press down on the metering stack 104 with the press bar 202 of the reader 200 with sufficient force to allow the expression of the target sample. As such, in one embodiment, as shown in FIGS. 9A and 9B, the first top layer 108A′ may not be continuous and/or a thickness of the top layer 108 at some areas is at least partially reduced. For instance, the second top layer 108B may extend directly vertically above the entire channel 114, whereas the first top layer 108A′ may extend directly above only a portion of the channel 114. For example, the first top layer 108A′ may include a first layer portion 109A and a second layer portion 109B that are at least partially spaced apart along the longitudinal direction LG1 by a gap distance GD1 such that a window is defined in the first top layer 108A′ where a thickness of the top layer 108 is reduced vertically above the dispensing sites 122 in the vertical direction V1 to lessen the force needed to insert the metering stack 104 into the reader 200. The thickness of the first and second layer portions 109A, 109B may be from 0.05 mm to 0.5 mm, whereas the thickness of the window portion may be 0 mm.

However, in other instances, a third layer portion (not shown) of the first top layer 108A′ extends across the gap distance GD1 and has a thickness less than the first and second layer portions 109A, 109B may be from 0.05 mm to 0.5 mm, but greater than zero. The gap distance GD1 may be greater than or equal to the length of the dispensing sites 122 in the longitudinal direction LG1. For instance, the length of the dispensing sites 122 in the longitudinal direction LG1 may be from 1.5 mm to 6.5 mm, whereas the gap distance GD1 may be from 1.5 mm to 7 mm.

In some instances, the top layer 108 may include one or more top layer protrusions or “press features” 113 (e.g., first press feature 113A, second press feature 113B, third press feature 113C, fourth press feature 113D, fifth press feature 113E) spaced apart along the lateral direction LT1. Each of the press features 113 may be vertically aligned with a respective one of the dispensing sites 122 in the vertical direction V1. The press features 113 may be positioned within the window of the first top layer 108A′, or may be positioned on top of the first top layer 108A or between the first and second top layers 108A, 108B when the first top layer 108A is without the window. The press features 113 may change (e.g., increase) a thickness of the top layer 108 above the dispensing sites 122 to help the press bar 202 of the reader 200 contact and sufficiently press against the dispensing sites 122 with less pressure needed on the press bar 202. As such, the thickness of the top layer 108 with the press features 113 may be thicker than without the press features 113. For example, the thickness of the press features 113 in the vertical direction V1 may be the same as or thicker than the first top layer 108A′ with the window. For instance, the press features 113 may have a thickness from 0.05 mm to 0.5 mm in the vertical direction V1, whereas the first top layer 108A, 108A′ may have a thickness from 0.05 mm to 0.5 mm. Additionally, in some instances, the press features 113 have a smaller area than the dispensing sites 122. For example the length of the press features 113 in the longitudinal direction LG1 may be smaller than a length of the dispensing sites 122 in the longitudinal direction LG1. For instance, the length of the press features 113 in the longitudinal direction may be from 1 mm to 5 mm, whereas the length of the dispensing sites 122 in the longitudinal direction LG1 may be from 1.5 mm to 6.5 mm. Similarly, a lateral width of the press features 113 may be less than a lateral width of the dispensing sites 122 in the lateral direction LT1. For example, the press features 113 may have the same dimensions in the lateral direction LT1 as in the longitudinal direction LG1, similarly, the dispensing sites 122 may have the same dimensions in the lateral direction LT1 as in the longitudinal direction LG1. In one instance, the entire length in the longitudinal direction LG1 of the press features 113 extends directly vertically above the dispensing sites 122. In some instances, the length of the press features 113 in the longitudinal direction LG1 is less than the gap distance GD1 when the window is present in the first top layer 108A′. It should be appreciated that, in some embodiments, instead of being discrete press features 113, the press features 113 may be connected to each other.

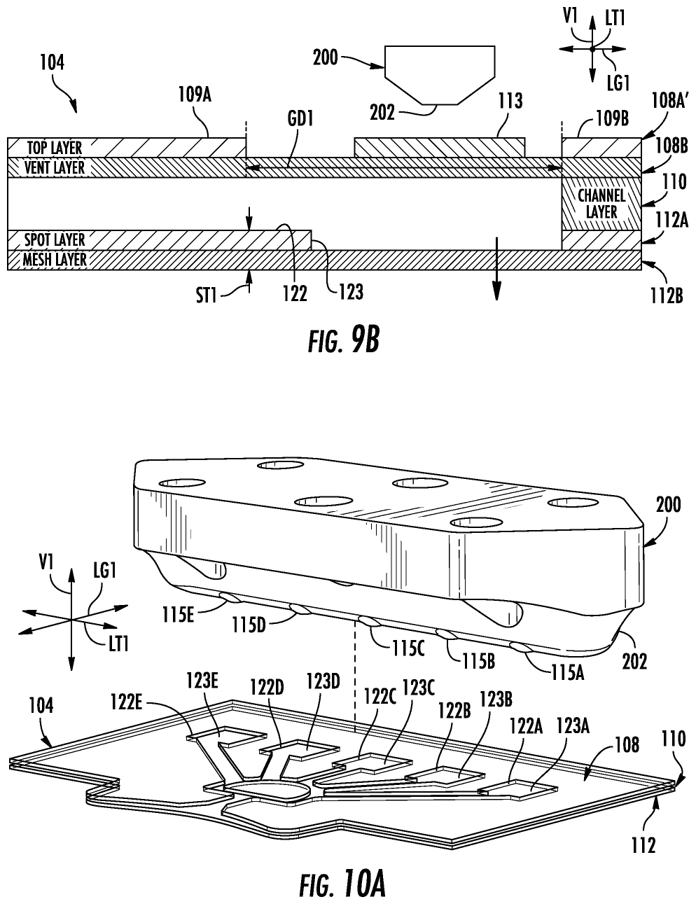

In some embodiments, as shown in FIGS. 10A and 10B, the press bar 202 of the reader 200 may include press bar protrusions or “bumps” 115 (e.g., first bump 115A, second bump 115B, third bump 115C, fourth bump 115D, fifth bump 155E) protruding in the vertical direction V1 from the press bar 202 and spaced apart from each other along the lateral direction LT1. For instance, the bumps 115 may extend from 0.05 mm to 5 mm from the press bar 202 in the vertical direction V1. Each of the bumps 115 on the press bar 202 may be vertically aligned with a respective one of the dispensing sites 122 in the vertical direction V1. The bumps 115 may similarly be configured to help the press bar 202 of the reader 200 contact and sufficiently press against the dispensing sites 122 with less force required to be applied to the press bar 202. The bumps 115 may have any suitable shape, such as cylindrical, inverted pyramid, inverted dome, and/or the like. The portion of the bumps 115 that contacts the metering stack 104 may be smaller than the dispensing sites 122 in at least one of the longitudinal and lateral directions LG1, LT1. It should be appreciated that the bumps 115 on the press bar 202 may be used with the first top layer 108A′ having the window, with the first top layer 108A without the window, and with or without the press features 113.

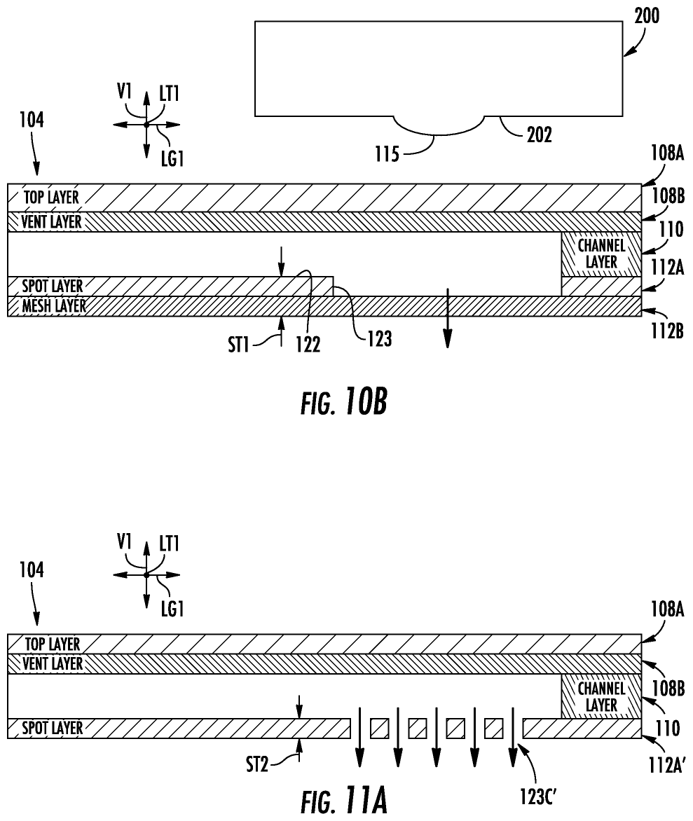

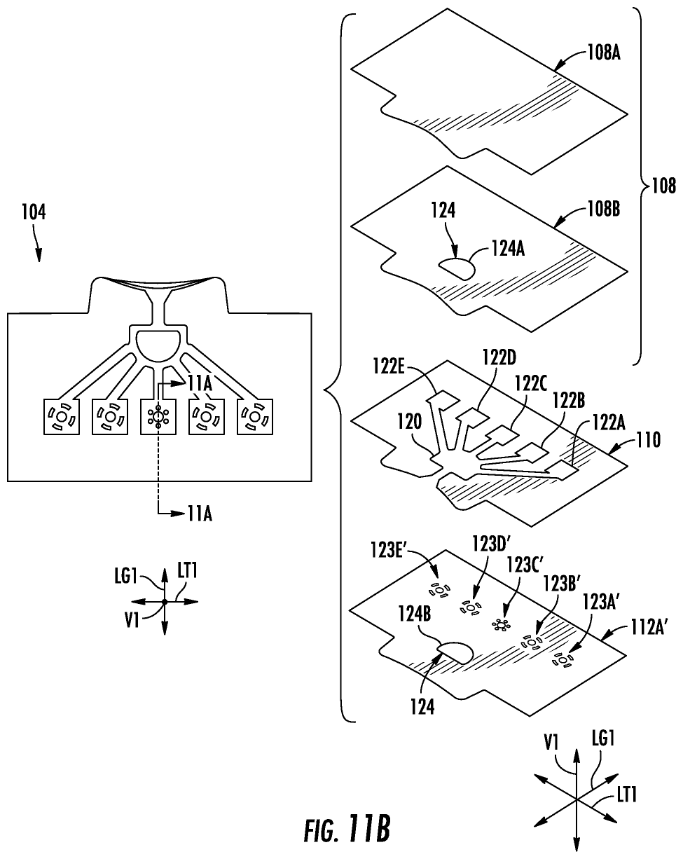

Turning now to FIGS. 11A-12, various features of the bottom layer 112 are shown that help facilitate a faster filling of the dispensing sites 122 while also reducing pressure required to dispense the target sample from the dispensing sites. For instance, in FIGS. 9B and 10B, the fluid flowing from the inlets 121 through the stem channels has to change direction to travel down into the outlets 123 in the first bottom layer 112A and through the porous second bottom layer 112B, which slows down the target sample. To reduce the distance the fluid has to travel down into the dispensing sites 122, as shown in FIGS. 11A and 11B, in some embodiments, the bottom layer 112 only includes the first bottom layer 112A′ made of non-porous material. In such embodiments, the first bottom layer 112A′ has one or more openings 123′vertically aligned with each of the dispensing sites 122. The openings 123′ are sized such that the biological fluid does not dispense from the dispensing sites 122 without pressure from the press bar 202 of the reader 200. For instance, the openings 123′ may each have a size (e.g., diameter, major axis, etc.) from 0.02 mm to 1 mm. A thickness ST2 of the single bottom layer 112A′ is less than a thickness ST1 (FIG. 9B) of the first bottom layer 112A (FIG. 9B) and the second bottom layer 112B (FIG. 9B) together, which reduces pressure required to dispense the target sample from the dispensing sites. For instance, the thickness ST2 may be from 0.01 mm to 0.1 mm. The openings 123′ may be laser cut, die cut, chemically machined, etc. into the single bottom layer 112A′. The shape and/or pattern of the openings 123′ for a given dispensing site 122 may be selected based at least in part on the analyte to be analyzed based on the fluid dispensed from the given dispensing site 122. For example, as shown in FIG. 11B, the shape and pattern of the openings 123C′ associated with the third dispensing site 122C is different from the shape and pattern of the openings 123A′, 123B′, 123D′, 123E′ associated with the other dispensing sites 122A, 122B, 122D, 122E. The top surface of the single bottom layer 112A′ (e.g., facing the channel 114) at least proximate the dispensing sites 122 may be hydrophilic to facilitate blood flow through the bottom layer 112A′.

In some embodiments, as shown in FIG. 12, the bottom layer 112 still has two different material layers 112A″, 112B″, however, the layers 112A″, 112B″ at least partially overlap in the vertical direction V1, such that the target sample is slowed less. For instance, the first bottom layer 112A″ may be made from an impermeable material and the second bottom layer 112B″ may be made from a permeable material (e.g., having a mesh or pore size from 10 μm to 1 mm). The first bottom layer 112A″ may be melted, deformed, or impressed into and/or printed or deposited onto the second bottom layer 112B″ to mesh with the second bottom layer 112B″ and at least partially overlap the second bottom layer 112B″ in the vertical direction V1. For instance, one or multiple layers of liquid material (e.g., UV curable ink) may be deposited in a predefined pattern (e.g., by inkjet printing, screen printing, spray printing, etc.) onto the second bottom layer 112B″ and allowed to at least partially permeate the porous second bottom layer 112B″ before being solidified to form the first bottom layer 112A″. In some instances, a pre-cut solid or gel-like adhesive material having a predefined pattern may be applied onto the mesh, and then bonded to the mesh under heat, pressure or other condition. A thickness ST3 of the first bottom layer 112A″ and the second bottom layer 112B″ together is less than a thickness ST1 (FIG. 9B) of the first bottom layer 112A (FIG. 9B) and the second bottom layer 112B (FIG. 9B) together, which reduces pressure required to dispense the target sample from the dispensing sites. For instance, the thickness ST3 may be from 0.01 mm to 0.1 mm. The top surface of the second bottom layer 112B″ at least proximate the dispensing sites 122 may be hydrophilic to facilitate blood flow through the bottom layer 112A′. In some instances, the top surface of the second bottom layer 112B″ (e.g., facing the channel 114) at least proximate the dispensing sites 122 may be more hydrophilic than the other surfaces (e.g., bottom surface) of the second bottom layer 112B″ to encourage the biological fluid to stay in the channel 114 before being inserted in the reader 200.

With the various configurations of the metering stack 104 described above with reference to FIGS. 1-12, it should be appreciated that the fluid dispensed from the dispensing sites 122 may be received by respective assay pads of an assay stack (not shown) positioned vertically beneath the metering stack 104 in the cartridge 102. The assay pads may have chemicals that react with the target analyte(s). The assay reader 200 may utilize reflectance spectroscopy to determine the concentration of the target analyte (e.g., hemoglobin) in a fluid sample received by the assay pads. As known by one of skill in the art, reflectance spectroscopy refers to measuring light as a function of wavelength that has been reflected or scattered from a surface. The use of reflectance spectroscopy lends itself well to POC diagnostics as it allows for dry chemistry techniques to be used in the manufacturing process, simplified design of the electronics, and the advantage of using a vertical flow architecture for sample collection and delivery. Further, reflectance spectroscopy does not require turbidity correction that is required in transmission spectroscopy, which can lead to erroneous results as discussed in detail above.

In an exemplary embodiment, reader 200 may detect light absorption and/or reflectance of a particular wavelength, which may indicate color changes of the assay pads after reacting with the biological fluid. To achieve this, assay reader 200 includes a plurality of light sources (not shown), light detection elements (e.g., photodiode arrays, CCD chips, and CMOS chips), and optical elements (e.g., apertures, lenses, light guides, bandpass filters, optical fibers, shutters, and the like) arrayed within assay reader 200 such that they align with the assay pads. In order for light detection elements to be able to detect changes in light absorption and/or reflectance associated with changes the color of the assay pads, a support surface of the reader 200 may be equipped with one or more apertures or be fabricated from a transparent material that allows light to penetrate therethrough. However, it is also to be understood that the assay reader 200 can alternatively include components to detect electrochemical or fluorescent changes in a detection membrane portion of the assay stack.

As an example, the outputs from light detection devices (e.g., photodiodes) may be sent to transimpedance amplifier/low pass filter elements, which convert the current signal from the photodiodes to a voltage output, while filtering unwanted signal components. The output from transimpedance amplifier/low pass filter elements are sent to an analog-to-digital converter unit, which includes a multiplexer unit, gain, and an analog-to-digital converter.

The output of the analog-to-digital converter unit may be sent to a component, which may be a second MCU SPI bus, a transmitter, or a processor. In certain embodiments, the transmitter allows for hardwired or wireless connectivity (e.g., Bluetooth or Wi-Fi) with a personal computer, mobile device, or computer network. In one particularly useful embodiment, the assay results are transmitted to the user's mobile device or personal computer, where they are displayed in a graphical user interface (GUI). If desired, the GUI may display prior assay results, in addition to the current results, in order to provide the user with information regarding the overall trends in the results of the assays. In addition, the assay results may be transmitted from the user's mobile device or computer to a computer network, such as one belonging to the user's physician. In this way, the assay systems of the present disclosure can allow a user's physician to monitor a patient closely, by providing up-to-date medical information from the assay results obtained by the assay reader 200.

It should be noted that the optical detection systems described in the foregoing correspond to some exemplary embodiments of the system, but that the present disclosure expressly contemplates other types of detection systems as well. In general, any detection system which corresponds to a signal change caused by an assay reaction may be used in connection with the assay reader of the present disclosure. Thus, for example, in certain embodiments, the detection system is an optical detection system that is based on chemiluminescence. In such embodiments, light sources such as LEDS and OLEDS are not required to detect changes in light absorption and/or reflectance when there are color changes caused by the assay reaction in the detection membranes. Rather, the signal change may be caused by the reaction of an oxidative enzyme, such as luciferase, with a substrate which results in light being generated by a bioluminescent reaction. In another exemplary embodiment, the signal change caused by the assay reaction may be detected by electrochemical reaction.

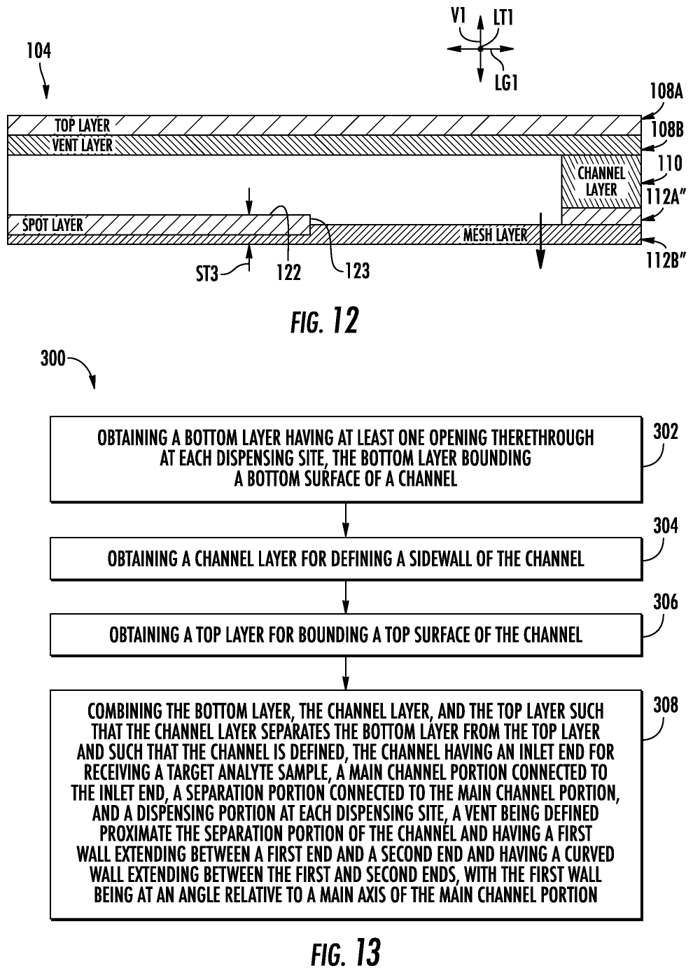

Turning now to FIG. 13, a flowchart is provided that illustrates a method 300 of fabricating a metering stack 104 according to one embodiment of the present disclosure.

The method 300, at (302), may include obtaining a bottom layer having at least one opening therethrough at each dispensing site, the bottom layer bounding a bottom surface of a channel. For instance, as described above, the metering stack 104 includes a bottom layer 112 defining a bottom of a channel 114 and at least one outlet opening 123 therethrough at each of the dispensing sites 122 of the channel 114.

The method 300, at (304), includes obtaining a channel layer for defining a sidewall of the channel. For instance, as discussed above, the metering stack 104 includes a channel layer 110 having a central opening defined therethrough that defines the sidewall of the channel 114.

The method 300, at (306), includes obtaining a top layer for bounding a top surface of the channel 114. For example, as described above, the metering stack 104 includes a top layer 108 defining a top surface of the channel 114.

Additionally, at (308), the method 300 includes combining the bottom layer, the channel layer, and the top layer such that the channel layer separates the bottom layer from the top layer and such that the channel is defined, the channel having an inlet end for receiving a target sample, a main channel portion connected to the inlet end, a separation portion connected to the main channel portion, and a dispensing portion at each dispensing site, a vent being defined proximate the separation portion of the channel and having a first wall extending between a first end and a second end and having a curved wall extending between the first and second ends, with the first wall being at an angle relative to a main axis of the main channel portion. For example, as indicated above, the channel layer 110 separates the bottom layer 112 from the top layer 108 when the layers 108, 110, 112 are combined or coupled together such that the channel 114 is defined. The channel 114 has the inlet end 116 for receiving a target sample, a main channel portion 118 connected to the inlet end 116, a separation portion 120 connected to the main channel portion 118, and a dispensing portion at each dispensing site 122. A vent 124 is defined within the metering stack 104 proximate the separation portion 120 of the channel 114. The vent 124 has a first wall 124F extending between a first end 124F1 and a second end 124F2 and having a curved wall 124C extending between the first and second ends 124F1, 124F2, with the first wall 124F being at an angle relative to a main axis Y1 of the main channel portion 118.

It should be appreciated that, while the metering stack 104 has been described with reference to separate layers, such as the top layer 108 (including the first top layer 108A, 108A′ and the second top layer 108B), the channel layer 110, and the bottom layer 112 (including the first bottom layer 112A, 112A′, 112AΔ, and the second bottom layer 112B, 112B″) which are combined to form the metering stack 104, the metering stack 104 may be formed in any other suitable manner. For instance, at least some features of one or more of the layers 108, 110, 112 may instead be formed as part of one or more of the other layers 108, 110, 112 (e.g., by molding, embossing, and/or the like).

Further to the descriptions above, a user may be provided with privacy-related controls allowing the user to make an election as to both if and when systems, programs, or features described herein may enable collection of health-related data and/or user information (e.g., information about a user's social network, social actions, or activities, profession, a user's preferences, or a user's current location), and if the user is sent content or communications that may be of a sensitive or private nature from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user. To that end, any information collected as described herein relating to the user (e.g., personal medical data, health conditions, etc.) is capable of being kept private and confidential and not be improperly used or published.

While various embodiments of the present disclosure have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the present disclosure, but instead as merely intended to highlight alternative or additional features that may or may not be utilized in a particular embodiment of the present disclosure. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A metering stack for collecting a target sample for testing, the metering stack comprising:
a top layer;
a bottom layer; and
a channel layer spacing the top layer from the bottom layer,
wherein the top layer, the bottom layer, and the channel layer together define a channel having an inlet end for receiving the target sample, a main channel portion connected to the inlet end, a separation portion connected to the main channel portion, and one or more dispensing portions connected to the separation portion, and
wherein a vent is defined within the metering stack proximate the separation portion of the channel, the vent having a first wall and a curved wall, the first wall extending between a first end and a second end, the curved wall extending between the first end and the second end, at least a portion of the first wall being closer than the curved wall to the main channel portion and with the first wall being at an angle relative to a main axis of the main channel portion, the vent allowing air to enter the metering stack into the separation portion.

2. The metering stack of claim 1, wherein the vent includes a first vent opening defined in the top layer.

3. The metering stack of claim 2, wherein the top layer includes a first top layer and a second top layer, the second top layer being closer to the channel layer than the first top layer, the first and second top layers being impermeable, the first vent opening being defined in the second top layer.

4. The metering stack of claim 2, wherein the bottom layer includes a first bottom layer and a second bottom layer, the first bottom layer being impermeable and the second bottom layer being permeable, and
wherein the vent includes a second vent opening defined in the first bottom layer such that air is allowed to enter into the separation portion through the second vent opening and towards the first vent opening.

5. The metering stack of claim 1, wherein the separation portion of the channel has a first flow path, a second flow path, and a third flow path through which the target sample flows around air entering the vent, the first flow path being defined proximate the first wall of the vent, the second flow path being defined between the first flow path and the third flow path, and the third flow path extending proximate the curved wall of the vent and being connected to each of the one or more dispensing portions.

6. The metering stack of claim 5, wherein the second flow path is substantially parallel to the main axis of the main channel portion.

7. The metering stack of claim 1, wherein the channel layer is at least partially spaced apart from one or both of the top layer and the bottom layer in a longitudinal direction at the inlet end.

8. The metering stack of claim 1, wherein the bottom layer has a plurality of openings associated with each of the one or more dispensing portions, the target sample being dispensable from each of the one or more dispensing portions via the plurality of openings.

9. The metering stack of claim 1, wherein the bottom layer includes a first bottom layer and a second bottom layer, the first bottom layer being impermeable and the second bottom layer being permeable, the first bottom layer and the second bottom layer at least partially overlapping in a vertical direction and at least partially along the channel.

10. The metering stack of claim 1, wherein the target sample is a fluid selected from a group comprising of blood, saliva, sweat, urine, lymph, tears, synovial fluid, breast milk, serum, plasma, bile, water, or a component thereof.

11. A testing system for collecting a target sample for testing, the testing system comprising:
a metering stack comprising:
a top layer;
a bottom layer; and
a channel layer spacing the top layer from the bottom layer,
wherein the top layer, the bottom layer, and the channel layer together define a channel having an inlet end for receiving the target sample, a main channel portion connected to the inlet end, a separation portion connected to main channel portion,
and one or more dispensing portions connected to the separation portion, and
wherein a vent is defined within the metering stack proximate the separation portion of the channel, the vent having a first wall and a curved wall, the first wall extending between a first end and a second end, the curved wall extending between the first and second ends, the first wall being at an angle relative to a main axis of the main channel portion, the vent allowing air to enter the metering stack into the separation portion; and
a reader configured to at least partially receive the one or more dispensing portions of the metering stack.

12. The testing system of claim 11, wherein the reader has a press bar configured to at least selectively press against the metering stack proximate the one or more dispensing portions such that the target sample in the one or more dispensing portions is dispensed from the metering stack, and
wherein the top layer of the metering stack has at least one top layer protrusion extending vertically above and away from the one or more dispensing portions, the press bar of the reader has at least one press bar protrusion configured to selectively press against the metering stack proximate the one or more dispensing portions, or both the top layer of the metering stack has the at least one top layer protrusion and the press bar of the reader has the at least one press bar protrusion.

13. The testing system of claim 12, wherein the one or more dispensing portions comprises a plurality of dispensing portions, the at least one top layer protrusion comprises a plurality of top layer protrusions, each of the plurality of top layer protrusions being vertically aligned with a respective one of the plurality of dispensing portions, the at least one press bar protrusion comprises a plurality of press bar protrusions, each of the plurality of press bar protrusions being associated with a respective one of the plurality of dispensing portions.

14. The testing system of claim 11, wherein the top layer comprises a first top layer and a second top layer, the first and second top layers being stacked in a vertical direction, the second top layer extending directly above the entire channel, the first top layer having a window extending directly above the one or more dispensing portions.

15. A metering stack for collecting a target sample for testing, the metering stack comprising:
a top layer;
a bottom layer; and
a channel layer spacing the top layer from the bottom layer in a vertical direction,
wherein the top layer, the bottom layer, and the channel layer together define a channel having an inlet end for receiving the target sample, one or more dispensing portions configured to receive the target sample from the inlet end, and a connecting portion connected between the inlet end and each of the one or more dispensing portions in a longitudinal direction to guide the target sample from the inlet end to each of the one or more dispensing portions, and
wherein the channel layer is at least partially spaced apart from one or both of the top layer and the bottom layer in the longitudinal direction at the inlet end.

16. The metering stack of claim 15, wherein the top layer is at least partially spaced apart from the bottom layer in the longitudinal direction at the inlet end.

17. The metering stack of claim 15, wherein a distance in the vertical direction between the channel layer and one or both of the top layer and the bottom layer is constant from the inlet end towards the connecting portion.

18. The metering stack of claim 15, wherein a distance in the vertical direction between the channel layer and one or both of the top layer and the bottom layer decreases from the inlet end towards the connecting portion.

19. The metering stack of claim 15, wherein a distance in the vertical direction at the inlet end between the channel layer and one or both of the top layer and the bottom layer decreases from a center of the metering stack in a lateral direction towards outer edges of the metering stack in the lateral direction.

20. The metering stack of claim 15, wherein the connecting portion of the channel includes a main channel portion connected to the inlet end, and a separation portion connected between the main channel portion and each of the one or more dispensing portions,
wherein a vent is defined in the metering stack proximate the separation portion, the vent having a first wall and a curved wall, the first wall extending between a first end and a second end in a lateral direction, the curved wall extending between the first and second ends, with the first wall being at an angle relative to a main axis of the main channel portion, the vent allowing air to enter the metering stack into the separation portion.
